(19) United States
(12) Patent Application Publication
(10) Pub. No.: US 2007/0170268 A1
(43) Pub. Date: Jul. 26, 2007

(54) Memory cards, nonvolatile memories and methods for copy-back operations thereof

(75) Inventor: Jung-Pil Lee, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/637,368

(22) Filed: Dec. 12, 2006

(30) Foreign Application Priority Data
Jan. 20, 2006 (KR) 10-2006-0006242

(51) Int. Cl. G06K 19/06

(52) U.S. Cl. 235/492

(57) ABSTRACT

Memory cards are provided including a memory controller and a nonvolatile memory. The nonvolatile memory is configured to perform a copy-back operation responsive to an instruction from the memory controller. The nonvolatile memory includes a cell array, a page buffer and a data comparator. The cell array includes a plurality of pages. The page buffer is configured to read data from a source page of the plurality of pages and the source page is selected by the memory controller. The data comparator is configured to determine whether a reading failure occurred during a read operation. The memory controller is configured to correct the reading failure of the read data of the page buffer and transfer the corrected data to the page buffer if it is determined that a reading failure has occurred. Related nonvolatile memories and copy-back operations are also provided herein.

### CLAIM OF PRIORITY

This application is related to and claims priority from Korean Patent Application No. 2006-06242 filed on Jan. 20, 2006, in the Korean Intellectual Property Office, the disclosure of which is hereby incorporated herein by reference as if set forth in its entirety.

### FIELD OF THE INVENTION

The present invention generally relates to integrated circuit devices and, more particularly, to memory cards and related methods.

### BACKGROUND OF THE INVENTION

Memory cards typically include nonvolatile memories and memory controllers operating the nonvolatile memories. Nonvolatile memories may be generally classified into electrically erasable/programmable read-only memories (EEPROMs), flash memories, phase-changeable random access memories (PRAMs), magnetic random access memories (MRAMs), and ferroelectric random access memories (FRAMs). The memory cards including flash memories may be called flash cards. Such memory cards can be distinguished into various types of MultiMedia Cards (MMCs), Secure Digital (SD) cards, Compact Flashes, Memory Sticks, and so on in accordance with manufacturers, different from each other in operation speed, card size, and security level. As the memory cards are capable of storing several hundreds of megabytes of data, they are widely used in portable electronic apparatuses, such as digital cameras, camcorders, gaming machines, and so forth.

Referring now to FIG. 1, a block diagram illustrating a conventional memory card will be discussed. As illustrated therein, the memory card 100 includes a nonvolatile memory 110 and a memory controller 120. The nonvolatile memory 110 includes a cell array 111 including a plurality of pages, for example, pages 113 . . . 115, and a page buffer 117 for writing data in and/or reading data from the cell array 111. The page buffer 117 is configured to temporarily store data that is read out from or to be written into the cell array 111. The memory controller 120 executes commands for accessing data stored in the nonvolatile memory 110 in response to requests by a host (not shown).

In operation, the memory card 100 may be instructed by the memory controller 120 to execute a copy-back operation therein. The copy-back operation internally transcribes data into a target page from a source page without access to the memory controller 120. The use of the copy-back operation may improve performance of the memory card 100.

For example, if there is a request, which comes from the host, for copying data from the page A (113 or the source page) into the page B (115 or the target page), the memory controller 120 may be configured to determine the possibility of copy-back and output a copy-back command CB to the nonvolatile memory 110. The nonvolatile memory 110 may be further configured to carry out a copy-back operation in response to the copy-back command CB. Through the copy-back operation, the data of the source page 113 is first read out by the page buffer 117 and the read data is programmed into the target page 115.

In the nonvolatile memory 110, reading and/or writing failures may occur frequently during the copy-back operation. The reading failure is generated while reading data into the page buffer 117 out of the source data 113, and the writing failure is generated while programming the read data (i.e., source data) into the target page 115 from the page buffer 117.

Even with such failures, as illustrated in FIG. 1, the conventional memory card 100 may be incapable of checking the reading or writing failures during the copy-back operation. Thereby, one or more copy-back operations may result in N-bit errors, where N is an integer greater than 2. In other words, incorrectable data errors may be generated by the memory controller 120, which may degrade the data reliability thereof.

### SUMMARY OF THE INVENTION

Some embodiments of the present invention provide memory cards including a memory controller and a nonvolatile memory. The nonvolatile memory is configured to perform a copy-back operation responsive to an instruction from the memory controller. The nonvolatile memory includes a cell array, a page buffer and a data comparator. The cell array includes a plurality of pages. The page buffer is configured to read data from a source page of the plurality of pages and the source page is selected by the memory controller. The data comparator is configured to determine whether a reading failure occurred during a read operation. The memory controller is configured to correct the reading failure of the read data of the page buffer and transfer the corrected data to the page buffer if it is determined that a reading failure has occurred.

In further embodiments of the present invention, the nonvolatile memory may be configured to perform the copy-back operation such that the data is transcribed into a target page from the source page without access to the memory controller.

In still further embodiments of the present invention, the memory controller may include a status checker and a data receiver. The status checker may be configured to instruct the nonvolatile memory to output the data from the page buffer responsive to a comparison result of the data comparator. The data receiver may be configured to receive the data from the page buffer responsive to the instruction of the status checker. In certain embodiments of the present invention, the status checker may be configured to instruct the nonvolatile memory to transfer the data into the data receiver from the page buffer when the comparison result indicates that the reading failure has occurred.

In some embodiments of the present invention, the memory controller may include an error check and correction (ECC circuit, a buffer and a data transmitted. The ECC circuit may be configured to find and repair a failure of data stored in the data receiver. The buffer may be configured to store data corrected by the ECC circuit. The data transmitter may be configured to transfer the corrected data from the buffer into the page buffer. The corrected data may be stored in the target page designated by the memory controller.

In further embodiments of the present invention, the data comparator may be further configured to determine whether there a writing failure has occurred while storing the corrected data into the target page.

In still further embodiments of the present invention, the memory controller m may be further configured to instruct the nonvolatile memory to change the target page when the comparison result of the data comparator indicates the writing failure. In certain embodiments of the present invention, the memory controller may be further configured to instruct the nonvolatile memory to change the target page whenever the writing failure occurs.

Although embodiments of the present invention are primarily discussed above with respect to memory cards, nonvolatile memories and methods for copy-back operations thereof are also provided herein.

### BRIEF DESCRIPTION OF THE DRAWINGS

FIG. 1 is a block diagram illustrating a conventional memory card.

FIG. 2 is a block diagram illustrating memory cards according to some embodiments of the present invention.

FIG. 3 is a flowchart illustrating copy-back operations for memory cards according to some embodiments of the present invention.

### DETAILED DESCRIPTION OF EMBODIMENTS OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

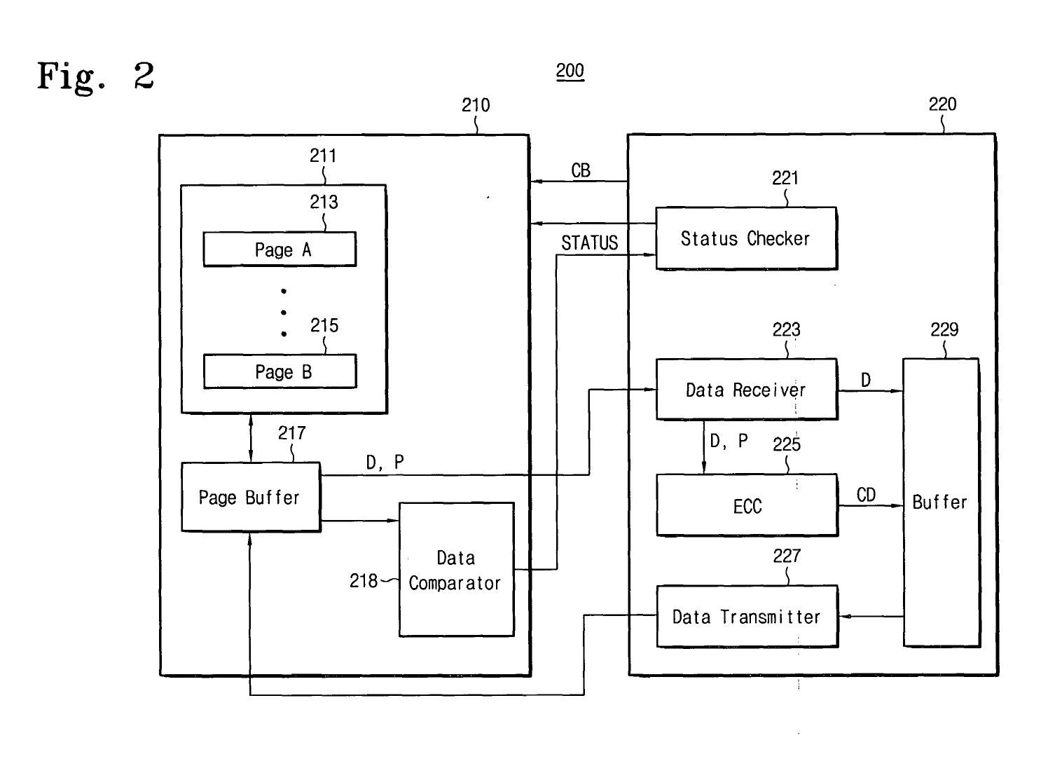

Referring first to FIG. 2, a block diagram illustrating memory cards according to some embodiments of the present invention will be discussed. As illustrated therein, the memory card 200 according to some embodiments of the present invention includes a nonvolatile memory 210 and a memory controller 220. The memory card 220 may be, for example, an MMC, Secure digital™ card, Memory Stick™, Compact Flash™, Smart Media™ or the like. The nonvolatile memory 210 may be, for example, an EEPROM, a NOR flash memory, a NAND flash memory, a PRAM, an MRAM, or an FRAM. The memory controller 220 is configured to execute commands for accessing data stored in the nonvolatile memory 210 in compliance with requests by a host (not shown).

As further illustrated in FIG. 2, the nonvolatile memory 210 includes a cell array 211 including a plurality of pages, for example, 213 . . . 215, a page buffer 217, and a data comparator 218. The page buffer 217 is configured to read data from a source page, for example, 213, among the plurality of pages, selected by the memory controller 220 and then store the read data therein. The data comparator 218 is configured to determine whether there is a reading failure while reading the data from the source page, and then output a result of the determination to the memory controller 220.

As illustrated in FIG. 2, the memory controller 220 includes a status checker 221, a data receiver 223, an error check and correction (ECC) circuit 225, a data transmitter 227, and a buffer 229. The status checker 221 is configured to receive the determination result from the data comparator 218, and the data receiver 223 is configured to accept data from the page buffer 217. The ECC circuit 225 is configured to check and correct an error of data provided from the data receiver 223. The buffer 229 is configured to store data corrected by the ECC circuit 225, and the data transmitter 227 is configured to transfer the corrected data to the page buffer 217.

Some embodiments of the present invention may provide memory cards 200 having improved performance by configuring the memory controller 220 to instruct the nonvolatile memory 210 to execute a copy-back operation therein. The copy-back operation internally transcribes data into the target page from the source page without access to the memory controller 220, thus, possibly enhancing the performance of the memory card 200.

While the memory controller 220 is generally equipped with the ECC circuit 225 for finding and repairing an error generated while reading or writing data, the ECC circuit 225 cannot be used therein because the copy-back operation is carried out without access to the memory controller 220.

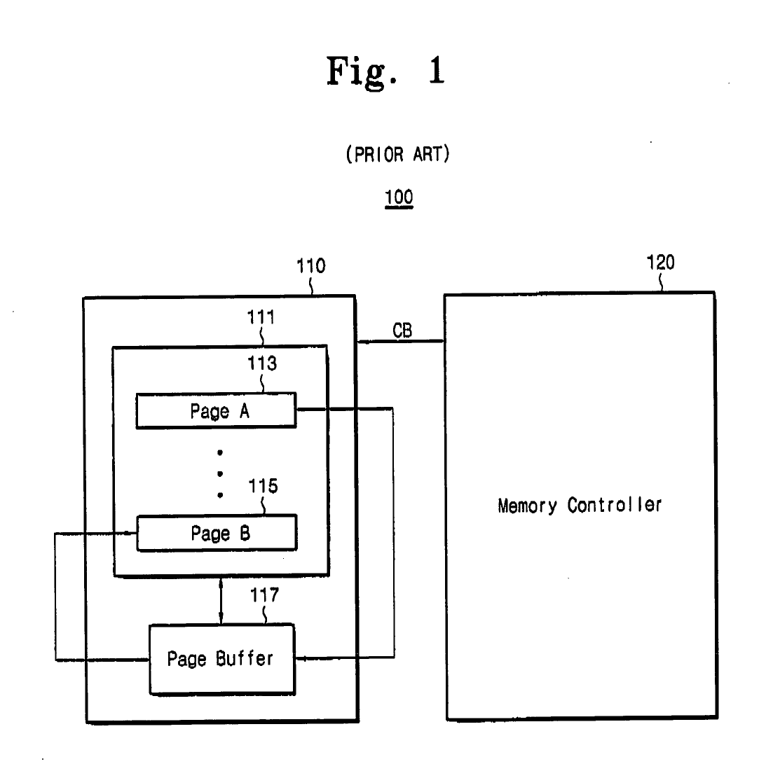

The conventional memory card 100 illustrated in FIG. 1 would be accompanied with data errors accumulated therein because there is no error check operation for reading or writing failures that may be generated while conducting the copy-back command CB. However, according to some embodiments of the present invention, the ECC circuit 220 of the memory controller 220 is configured to conduct the checking and correcting operation only when there is a 1-bit gap between the source data and the target data. Namely, if data errors are generated more than 2 bits by accumulation of reading or writing failures during the copy-back operation, even the ECC circuit 225 of the memory controller 220 may not repair such data errors to degrade the reliability of data thereby.

In order to address this issue, the memory card 200 according to some embodiments of the present invention includes the data comparator 218 and the status checker 221. For example, assuming that the host (not shown) requests to copy data from page A (the source page 213) into the page B (the target page 215), the memory controller 220 is configured to determine the possibility for the requested operation and output a copy-back command CB to the nonvolatile memory 210. Responding to an input of the copy-back command CB, the nonvolatile memory 210 begins a read operation to copy data from the source page 213 into the page buffer 217. The data comparator 218 id configured to detect whether there is a reading failure on the data read into the page buffer 217. The data comparator 218 is configured to provide a detection result STATUS to the status checker 221 of the memory controller 220. The status checker 221 is configured to instruct the nonvolatile memory 210 to transfer data of the page buffer 217 in response to the detection result STATUS. In other words, if data of the source page 213 is the same as the data of the page buffer 217, i.e., if there is no reading failure, the status checker 221 is configured to instruct the nonvolatile memory 210 not to transfer the data to the memory controller 220 but to continue the next operation, for example, a write operation.

If, on the other hand, data of the source page 213 is not the same as the data of the page buffer 217, i.e., if there is a reading failure, the status checker 221 is configured to instruct the nonvolatile memory 210 to transfer data D from the page buffer 217 into the data receiver 223. During this, parity data P, as well as the data D is also transferred to the memory controller 220, so the memory controller 220 conducts the checking and correcting operations for the data D. In particular, first, the data receiver 223 provides the data D, which is transferred from the page buffer 217, to the buffer 229. The data D is temporarily stored in the buffer 217. At the same time, the data receiver 223 also sends the parity data P to the ECC circuit 225 along with the data D. Corrected data CD from the ECC circuit 255 is transferred to the buffer 229. The buffer 229 is updated with the corrected data CD. The data transmitter 227 sends the corrected data D to the page buffer 217.

Once this process is complete, the write operation may begin. The corrected data CD is transcribed from the page buffer 217 into the target page 215 designated by the memory controller 220. After completing the write operation for transcription, the data comparator 218 is configured to determine whether a writing failure has been generated during the write operation with the corrected data into the target page 215. The status checker 221 is configured to instruct the nonvolatile memory 210 to change the target page in response to the detection result STATUS.

If data of the target page 215 matches with the corrected data CD held at the page buffer 217, i.e., if there is no writing failure, the status checker 221 is configured to instruct the nonvolatile memory 210 to terminate the copy-back operation. If, on the other hand, data of the target page 215 is different from the corrected data CD held at the page buffer 217, i.e., if there is a writing failure, the status checker 221 is configured to instruct the nonvolatile memory 210 to change the target page. For this, the error-corrected data CD saved in the memory controller 220 is provided into the page buffer 217 and copied into the new target page from the page buffer 217. Thereafter, as discussed above, the data comparator 218 repeatedly determines whether there another writing failure is generated. The write operation is repeated until no writing failure is detected.

Thus, according to some embodiments of the present invention, reading and writing failures generated during the copy-back operation may be located and repaired, thereby possibly enhancing the reliability of data in the memory card according to some embodiments of the present invention.

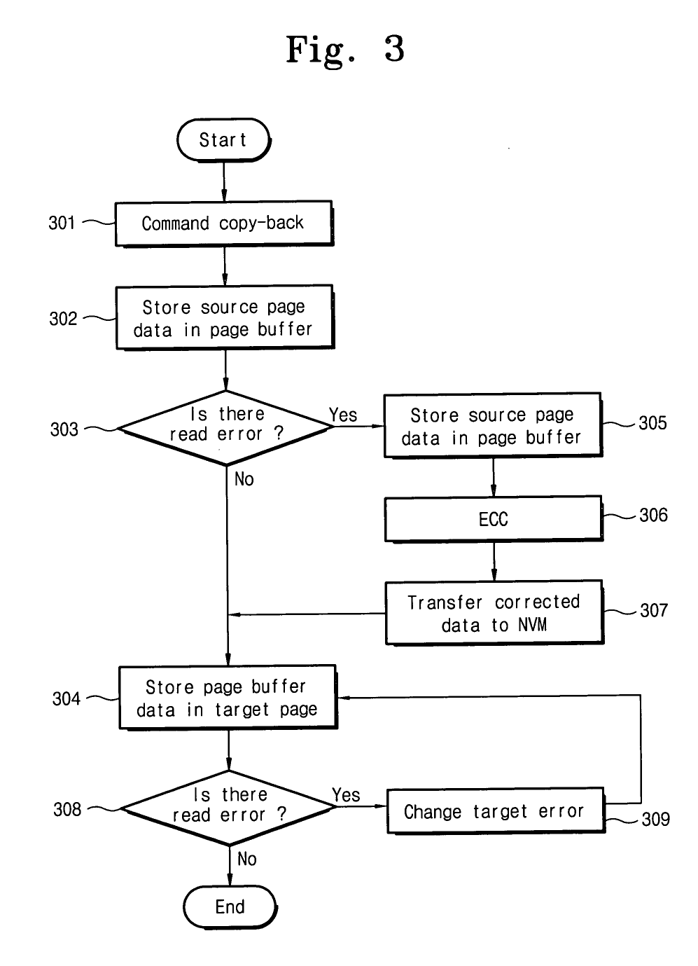

Referring now to FIG. 3, a flow chart illustrating a copy-back operation in the memory card according to some embodiments the present invention will be discussed. As illustrated in FIG. 3, operations begin at block 301 receiving a copy-back command from a host. The memory controller 210 instructs the nonvolatile memory 210 to begin the copy-back operation with addresses of the source and target pages (block 301) responsive to the request from the host.

The page buffer 217 of the nonvolatile memory 210 reads data from the source page and temporarily stores the read data therein (block 302). The data comparator 218 determines whether there is a reading failure while reading the data from the source page (block 303). If it is determined that a reading failure has not occurred (block 303), i.e., if the data of the source page agrees with the data of the page buffer 217, the data of the page buffer 217 is stored into the target page (block 304). If, on the other hand, it is determined that a reading failure has occurred, i.e., if the data of the source page disagrees with the data of the page buffer 217, the data of the page buffer 217 is transferred to the memory controller 220 (block 305). Thus, in some embodiments of the present invention, the status checker 221 may instruct the nonvolatile memory 210 to output the data from the page buffer 217, in response to the determination result from the data comparator 218. The data transferred to the memory controller 220 is provided to the ECC circuit 225 through the data receiver 223 and at the same time is stored temporarily in the buffer 229 through the data receiver 223. The ECC circuit 225 conducts the error-checking and correcting operation for the transferred data (block 306). The data held at the buffer 229 is updated with the data corrected by the ECC circuit 225.

The corrected data is re-transferred to the page buffer 217 of the nonvolatile memory 210 (block 307) and operations proceed to block 304 for executing a programming (or writing) operation to the target page.

Once the data of the page buffer 217 has been programmed in the target page, the data comparator 218 determines whether a writing failure has occurred (block 308). In other words, the data of the target page is compared with the data of the page buffer. If it is determined that no writing failure has occurred (block 308), i.e., if those data are identical to each other, the copy-back operation is terminated. If, on the other hand, it is determined that a writing failure has occurred, i.e., if those data are different from each other, the status checker 221 instructs the nonvolatile memory 210 to change the target page (block 309), in response to the result of the data comparator 218 that informs there is a writing failure. Operations proceed through block 304 for programming the data of the page buffer 217 into the target page (the new target page). Operations of blocks 304, 308, and 309 may be repeated until no writing failure is detected therethrough.

As discussed briefly above with respect to FIGS. 2 and 3, some embodiments of the present invention include a memory card and an associated copy-back method that may allow reading and/or writing failures to be located and verified even during the copy-back operation, which may improve the reliability of data therein.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A memory card comprising:
a memory controller; and
a nonvolatile memory configured to perform a copy-back operation responsive to an instruction from the memory controller, the nonvolatile memory comprising:
a cell array including a plurality of pages;
a page buffer configured to read data from a source page of the plurality of pages, the source page being selected by the memory controller; and
a data comparator configured to determine whether a reading failure occurred during a read operation, the memory controller being configured to correct the reading failure of the read data of the page buffer and transfer the corrected data to the page buffer if it is determined that a reading failure has occurred.

2. The memory card of claim 1, wherein the nonvolatile memory is configured to perform the copy-back operation such that the data is transcribed into a target page from the source page without access to the memory controller.

3. The memory card of claim 2, wherein the memory controller comprises:
a status checker configured to instruct the nonvolatile memory to output the data from the page buffer responsive to a comparison result of the data comparator; and
a data receiver configured to receive the data from the page buffer responsive to the instruction of the status checker.

4. The memory card of claim 3, wherein the status checker is configured to instruct the nonvolatile memory to transfer the data into the data receiver from the page buffer when the comparison result indicates that the reading failure has occurred.

5. The memory card of claim 4, wherein the memory controller further comprises:
an error check and correction (ECC) circuit configured to find and repair a failure of data stored in the data receiver;
a buffer configured to store data corrected by the ECC circuit; and
a data transmitter configured to transfer the corrected data from the buffer into the page buffer.

6. The memory card of claim 5, wherein the corrected data is stored in the target page designated by the memory controller.

7. The memory card of claim 6, wherein the data comparator is further configured to determine whether a writing failure has occurred while storing the corrected data into the target page.

8. The memory card of claim 7, wherein the memory controller is further configured to instruct the nonvolatile memory to change the target page when the comparison result of the data comparator indicates the writing failure.

9. The memory card of claim 8, wherein the memory controller is further configured to instruct the nonvolatile memory to change the target page whenever the writing failure occurs.

10. A nonvolatile memory comprising:
a cell array composed of plurality of pages;
a page buffer configured to read data from one of the plurality of pages; and
a data comparator configured to determine whether a reading failure has occurred on the data read by the page buffer.

11. The nonvolatile memory of claim 10, further comprising a memory controller electrically coupled to the page buffer, the page buffer being configured to output the data of the page buffer to the memory controller for error correction when a comparison result from the data comparator indicates occurrence of a reading failure.

12. The nonvolatile memory of claim 11, wherein the page buffer is further configured to receive corrected data provided by the memory controller and store the received data into a target page.

13. The nonvolatile memory of claim 12, wherein the data comparator is further configured to determine whether a writing failure has occurred on the data stored in the target page.

14. The nonvolatile memory of claim 13, wherein the memory controller is further configured to change the target page to a new page when the comparison result indicates that a writing failure has occurred.

15. A method for copying-back in a memory card, the method comprising:
receiving a copy-back command from a host;
storing data in a page buffer from a source page responsive to the copy-back command; and
determining if a reading failure has occurred on the data stored in the page buffer.

16. The method of claim 15, further comprising storing the data in a target page from the page buffer when it is determined that no reading failure has occurred.

17. The method of claim 16, further comprising performing an error checking and correcting (ECC) operation on the data stored in the page buffer when it is determined that a reading failure has occurred.

18. The method of claim 17, further comprising:
storing corrected data in the page buffer after completing the error checking and correcting operation; and
storing the corrected data in the target page from the page buffer.

19. The method of claim 16, further comprising determining whether a writing failure has occurred while storing the corrected data in the target page.

20. The method of claim 19, further comprising:
changing the target page to a new page when it is determined that a writing failure has occurred; and
storing the corrected data in the new page.

21. The method of claim 18, further comprising determining whether a writing failure has occurred while storing the corrected data in the target page.

22. The method of claim 21, further comprising:
changing the target page to a new page when it is determined that a writing failure has occurred; and
storing the corrected data in the new page.
